(19) United States
(12) Patent Application Publication
(10) Pub. No.: US 2023/0362337 A1
(43) Pub. Date: Nov. 9, 2023

(54) LISSAJOUS DUAL-AXIAL SCAN COMPONENT

(71) Applicants: HUAWEI TECHNOLOGIES CO., LTD., Shenzhen (CN); FRAUNHOFER-GESELLSCHAFT ZUR FOERDERUNG DER ANGEWANDTEN FORSCHUNG E.V., Muenchen (DE)

(72) Inventors: Marcel REHER, Itzehoe (DE); Thomas Von WANTOCH, Itzehoe (DE); Ulrich HOFMANN, Itzehoe (DE); Oleg PETRAK, Itzehoe (DE); Christian JANICKE, Itzehoe (DE); Yong CAO, Itzehoe (DE)

(21) Appl. No.: 18/196,773

(22) Filed: May 12, 2023

Related U.S. Application Data
(63) Continuation of application No. PCT/EP2020/080207, filed on Nov. 13, 2020.

(51) Int. Cl. H04N 9/31; G02B 26/10; G02B 7/182

(52) U.S. Cl. CPC H04N 9/3161; H04N 9/312; G02B 26/101; G02B 7/1821

(57) ABSTRACT

The present disclosure provides a Lissajous dual-axial scan component (100) that includes an outer frame (102), a first pair of supports (104A-B), a second pair of supports (106A-B), an inner frame (108), a mirror (110), a sensing arrangement (112), a controller (114) and a memory (116). The memory (116) stores multiple tuples each including a first-axial bias frequency value, a second-axial bias frequency value, and a phase difference between actual driving frequencies (i.e. a first-axial bias frequency and a second-axial bias frequency) of the mirror (110). The controller (114) is coupled to the sensing arrangement (112) to receive signals indicative of current resonant frequencies of the mirror (110) and configured to select one of the tuples from the memory (116) based on the signals received from the sensing arrangement (112) and set the applied bias frequencies, and their phase difference, according to the selected tuple.

### TECHNICAL FIELD

The present application relates to a Lissajous dual-axial scan component and a method for controlling the Lissajous dual-axial scan component, and in particular such a component and method for a projection system.

### BACKGROUND

A projector is an optical device that receives an imaging signal and projects corresponding still images or moving images onto a display surface such as a screen or retina.

Many projection devices use a microelectromechanical systems (MEMS) mirror to reflect light onto a display surface (hereinafter referred to as a screen) or directly onto the retina of user's (retinal projection). The MEMS mirror oscillates on one or more oscillation axes to scan light across the screen for projecting an image on the screen or retina. For example, the MEMS mirrors, used in projection interfaces such as augmented reality and virtual reality applications, are arranged to oscillate on two orthogonal or near orthogonal axes to allow projection on the screen or retina.

Some projectors are arranged to scan in a raster scan arrangement, similar to the approach familiar from television systems. Alternatively, the scanning arrangement can produce a Lissajous figure whose shape is determined by the oscillation frequencies applied to the two oscillation axes, and the phase relationship between the two frequencies. The trajectory of the two-dimensional oscillations determines the degree of illumination on the display screen, also called line density or fill factor. If the oscillation frequencies are not properly controlled with respect to the degree of illumination, the Lissajous trajectory will change and may not be suited for any projection process. The Lissajous trajectory determines the degree of the illumination on the screen, and the Lissajous trajectory is determined by the oscillation frequencies on the two axes and their relative phase. Additionally, it may be desirable for total optical scan angles (TOSA) of the MEMS mirror to be maximized in MEMS scanning applications generally, as the TOSA determines the size of a projection surface. To achieve this, MEMS scanners are usually driven at their resonance frequencies on respective axes. However, the resonance frequencies are not constant over time, for example, they may be temperature dependent, so the Lissajous trajectory may change over time as well, leading to instability in illumination. In certain scenarios, the illumination on the screen even falls below 50% with the Lissajous based MEMS scanning projection systems. Such a low illumination percentage makes the projection of display contents at least unpleasant.

Therefore, there arises a need to address the aforementioned technical drawbacks in existing technologies in optimising high illumination on a display surface.

### SUMMARY

It is an object of the present disclosure to provide a Lissajous dual-axial scan component that enhances illumination and line density on a screen or retina and also provides a smooth visual perception of moving images.

This object is achieved by the features of the independent claims. Further implementation forms are apparent from the dependent claims, the description, and the figures.

The present disclosure provides a Lissajous dual-axial scan component and a method for controlling a Lissajous dual-axial scan component.

According to a first aspect, there is provided a Lissajous dual-axial scan component including:
an outer frame;
a first pair of supports defining a first rotational axis and configured to twist at a first-axis resonance frequency when the Lissajous dual-axial scan component is driven;
a second pair of supports defining a second rotational axis and configured to twist at a second-axis resonance frequency when the Lissajous dual-axial scan component is driven;
an inner frame connected to the outer frame through the second pair of supports;
a mirror connected to the inner frame through the first pair of supports;
a sensing arrangement to monitor the fast-axis resonance frequency and the second-axis resonance frequency; and
a controller to control application of a first-axial bias frequency, different from the first-axis resonance frequency, to cause rotation about the first rotational axis, and of a second-axial bias frequency, different from the second-axis resonance frequency, to cause rotation about the second rotational axis;
the Lissajous dual-axial scan component, when driven, scans according to a ratio of the first-axial bias frequency to the second-axial bias frequency;
a memory storing multiple tuples each comprising a first-axial bias frequency value, a second-axial bias frequency value, and a phase difference between the first-axial bias frequency and the second-axial bias frequency, and each tuple corresponding to a particular pair of ranges of First-axis and second-axis resonant frequencies;
the controller being coupled to the sensing arrangement to receive signals indicative of the resonant frequencies, and configured to:
select one of the tuples from the memory based on the signals received from the sensing arrangement; and
   set the applied bias frequencies; and their phase, according to the selected tuple.

The Lissajous dual-axial scan component may have both high mechanical stability and low operating voltages. Based on the combinations of the driving frequencies and their phase difference (φ) stored in the memory as topics, the Lissajous dual-axial scan component achieves high definition and high frame-rate (HDHF) scanning and enables a necessary degree of illumination and high line density during projection of images and videos. Each topic corresponding to the particular pair of ranges of first-axis and second-axis resonant frequencies that are stored in the memory provides settings that that ensure desired fill factor for the particular pair of resonant frequencies.

In a first possible implementation form of the Lissajous dual-axial scan component of the first aspect, the ratio of the first-axis resonance frequency to the second-axis resonance frequency is at least 20 to 1.

In a second possible implementation form of the Lissajous dual-axis scan component of the first possible implementation form, the ratio of the first-axis resonance frequency to the second-axis resonance frequency is at least 30 to 1,

In a third possible implementation form of the Lissajous dual-axial scan component of the second possible implementation, the ratio of the first-axis resonance frequency to the second-axis resonance frequency is at least 40 to 1. The above ratios of the first-axis resonance frequency to the second-axis resonance frequency enable the mirror of the Lissajous dual-axial scan component to provide high illumination and high line density on the screen or retina. Hereinafter, for convenience and ease of reading, we will refer simply to “screen”, but any reference to screen should be taken to mean “screen or retina” unless the context clearly requires otherwise.

In a fourth possible implementation form of the first aspect as such or according to any of the preceding implementation forms of the first aspect, the first and second rotational axes are orthogonal to each other.

In a fifth possible implementation form of the first aspect as such or according to any of the preceding implementation forms of the first aspect, the ratio of the first-axis resonance frequency to the second-axis resonance frequency is a rational number.

In a sixth possible implementation form of the first aspect as such or according to any of the first through fourth implementation forms of the first aspect, the ratio of the first-axis resonance frequency to the second-axis resonance frequency is an irrational number.

In a seventh possible implementation form of the first aspect as such or according to any of the preceding implementation forms of the first aspect, the controller is configured to drive the scan component with a frame repetition rate between 25 and 35 Hz (i.e. 25 Hz<fᵣₑₛ<35 Hz).

According to a second aspect, there is provided a visual display device including one or more Lissajous dual-axial scan components according to the first aspect as such or according to any of the preceding implementation forms of the first aspect.

In a first implementation form of the visual display device, the visual display device includes a direct digital synthesis device to generate the first-axial bias frequency and the second-axial bias frequency.

According to a third aspect, there is provided a method of fabricating a Lissajous dual-axial scan component according to the first aspect as such or according to any of the preceding implementation forms of the first aspect, the method including writing multiple tuples into a memory of the Lissajous dual-axial scan component, each tuple includes a first-axial bias frequency value, a second-axial bias frequency value, and a phase difference between the first-axial bias frequency and the second-axial bias frequency. Each tuple corresponds to a particular pair of ranges of first-axis and second-axis resonance frequencies. The Lissajous dual-axial scan component fabricated using the method of the third aspect may have both high mechanical stability and low operating voltages. The Lissajous dual-axial scan component achieves high illumination and high line density on a screen using combinations of the driving frequencies and their phase difference (φ) stored in a memory.

According to a fourth aspect, there is provided a method of controlling a Lissajous dual-axial scan component, the method including:
monitoring a first-axis resonance frequency of a first pair of supports defining a first rotational axis of the Lissajous dual-axial scan component and a second-axis resonance frequency of a second pair of supports defining a second rotational axis of the Lissajous dual-axial scan component;
controlling application of a first-axial bias frequency, different from the first-axis resonance frequency, to cause rotation about the first rotational axis, and of a second-axial bias frequency, different from the second-axis resonance frequency, to cause rotation about the second rotational axis;
based on signals received from the monitoring, selecting one tuple from a memory storing multiple tuples each comprising a first-axial bias frequency value, a second-axial bias frequency value, and a phase difference between the first-axial bias frequency and the second-axial bias frequency, and each tuple corresponding to a particular pair of ranges of first-axis and second-axis resonance frequencies; and
setting the applied bias frequencies, and their phase, according to the selected tuple.

The method of the fourth aspect controls the Lissajous dual-axial scan component to provide high illumination and high line density on a screen using the combinations of the driving frequencies and their phase difference (φ) stored in the memory as tuples. The Lissajous dual-axial scan component may have both high mechanical stability and low operating voltages.

In a first possible implementation form of the method of the fourth aspect, the method further includes
continuing monitoring the first-axis resonance frequency and the second-axis resonance frequency;
in response to a change in signals received from e monitoring selecting another tuple of the multiple stored tuples; and
setting the applied bias frequencies, and their phase, according to the selected another tuple.

In a second possible implementation form of the method of the fourth aspect as such or according to the first implementation form of the fourth aspect, the ratio of the first-axis resonance frequency to the second-axis resonance frequency is at least 20 to 1.

In a third possible implementation form of the method of the second possible implementation of the fourth aspect, the ratio of the first-axis resonance frequency to the second-axis resonance frequency is at least 30 to 1.

In a fourth possible implementation form of the method of the third possible implementation of the fourth aspect, the ratio of the first-axis resonance frequency to the second-axis resonance frequency is at least 40 to 1. The above ratios of the first-axis resonance frequency to the second-axis resonance frequency enable the mirror of the Lissajous dual-axial scan component to provide high illumination and high line density on the screen.

In a fifth possible implementation of the fourth aspect as such or according to any of the preceding implementations of the fourth aspect, the ratio of the first-axis resonance frequency to the second-axis resonance frequency is a rational number.

In a sixth possible implementation of the fourth aspect as such or according to any of the first to fourth preceding implementations of the fourth aspect, the ratio of the first-axis resonance frequency to the second-axis resonance frequency is an irrational number.

In a seventh possible implementation of the fourth aspect as such or according to any of the preceding implementations of the fourth aspect, the controlling of the first-axial and second-axial bias frequencies is such as to produce a frame repetition rate between 25 and 35 Hz.

A Lissajous dual-axial scan component according to the present disclosure may be used in any augmented reality or virtual reality (AR/VR) device relying on Lissajous based MEMS scanning to achieve a high illumination on a screen, e.g., glasses or goggles for the display of visual information, A Lissajous dual-axial scan component according to the present disclosure may be used in any form of projection of visual content onto a screen relying on Lissajous based MEMS scanning.

A technical problem in the prior art is resolved, where the technical problem is that the trajectory changes over time, for example, due to changes in system temperature leading to instability in illumination.

Therefore, compared with the prior art, according to the Lissajous dual-axial scan component and the method for controlling the Lissajous dual-axial scan component provided in the present disclosure, the Lissajous dual-axial scan component enables high illumination and line density on the screen, and provides the smooth visual perception of moving images by shifting driving frequencies, i.e. a first-axial bias frequency and a second-axial bias frequency and their phase difference (φ) of a mirror if any changes are identified in at least one of (a) a first-axis resonance frequency and (b) a second-axis resonance frequency. The Lissajous dual-axial scan component monitors the first-axis resonance frequency and the second-axis resonance frequency. Based on a change that is identified in at least one of (a) the first-axis resonance frequency and (b) the second-axis resonance frequency, the Lissajous dual-axial scan component switches settings based on pre-stored tuples.

These and other aspects of the present disclosure will be apparent from and the embodiment(s) described below.

### BRIEF DESCRIPTION OF DRAWINGS

Embodiments of the invention will now be described, by way of example only, with reference to the accompanying drawings, in which:

FIG. 1 is a block diagram of a Lissajous dual-axial scan component in accordance with an embodiment of the present disclosure;

FIGS. 2A-2I illustrate Lissajous curves for different values of a phase difference (φ) at same values of multiplicators nₓ and n_{y};

FIG. 3 is a Lissajous pattern that is close to a raster scan pattern, which allows a greater number of pixels of an image for scanning in accordance with an embodiment of the present disclosure;

FIG. 4 is an exemplary view that illustrates a visual display device that includes one or more Lissajous dual-axial scan components of FIG. 1 in accordance with an embodiment of the present disclosure; and

FIGS. 5A-5B are flow diagrams that illustrate a method of controlling a Lissajous dual-axial scan component in accordance with an embodiment of the present disclosure.

### DETAILED DESCRIPTION OF THE DRAWINGS

Embodiments of the present disclosure provide a Lissajous dual-axial scan component and a method for controlling the Lissajous dual-axial scan component to optimize illumination and line density on a screen and provide a smooth visual perception of moving images.

To make the solutions of the present disclosure more comprehensible for a person skilled in the art, the following clearly and completely describes the technical solutions in the embodiments of the present disclosure with reference to the accompanying drawings in the embodiments of the present disclosure. The described embodiments are provided merely by way of example. All other embodiments derived by a person of ordinary skill in the art based on the embodiments of the present disclosure without creative efforts shall fall within the protection scope of the present disclosure.

In order to help understand embodiments of the present disclosure, several terms that will be introduced in the description of the embodiments of the present disclosure are defined herein first.

Terms such as “a first”, “a second”, “a third”, and “a fourth” (if any) in the summary, claims, and foregoing accompanying drawings of the present disclosure are used to distinguish between similar objects and are not necessarily used to describe a specific sequence or order. It should he understood that the terms so used are interchangeable under appropriate circumstances, so that the embodiments of the present disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units, but may include other steps or units that are not expressly listed or that are inherent to such process, method, product, or device.

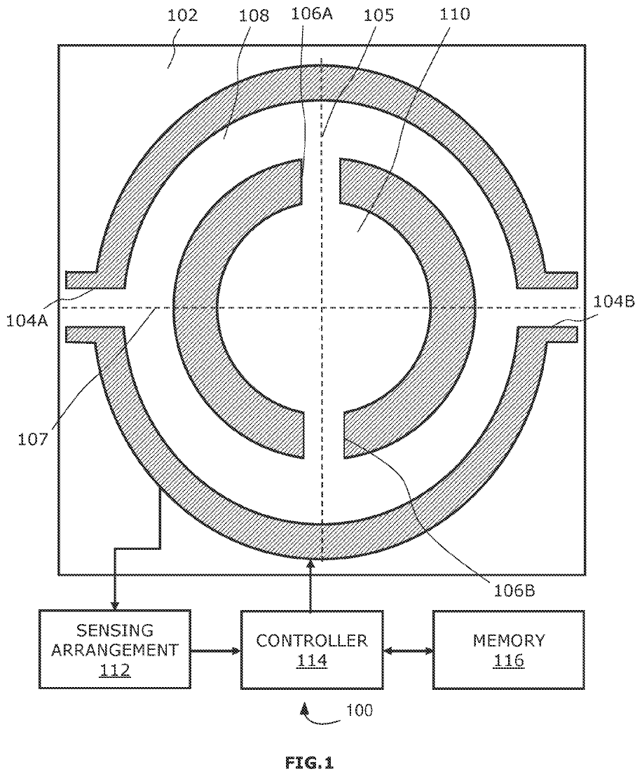

FIG. 1 is a block diagram of a Lissajous dual-axial scan component 100 in accordance an embodiment of the present disclosure. The Lissajous dual-axial scan component 100 includes an outer frame 102, a first pair of supports 104A-B, a second pair of supports 106A-B, an inner frame 108, a mirror 110, a sensing arrangement 112, a controller 114 and a memory 116. The memory will typically be a read only memory (ROM). The first pair of supports 104A-B defines a first rotational axis 105 and is configured to twist at a first-axis resonance frequency when the Lissajous dual-axial scan component 100 is driven. The second pair of supports 106A-B defines a second rotational axis 107 and is configured to twist at a second-axis resonance frequency when the Lissajous dual-axial scan component 100 is driven. The inner frame 108 is connected to the outer frame 102 through the second pair of supports 106A-B. The mirror 110 is connected to the inner frame 108 through the first pair of supports 104A-B. The sensing arrangement 112 monitors the first-axis resonance frequency and the second-axis resonance frequency of the mirror 110 when the Lissajous dual-axial scan component 100 is driven.

The controller 114 controls application of a first-axial bias frequency, different from the first-axis resonance frequency, to cause rotation about the first rotational axis 105, and of a second-axial bias frequency, different from the second-axis resonance frequency, to cause rotation about the second rotational axis 107. The first-axial bias frequency and the second-axial bias frequency are driving frequencies of the mirror 110 of the Lissajous dual-axial scan component 100.

The Lissajous dual-axial scan component 100 scans according to a ratio of the first-axial bias frequency to the second-axial bias frequency when the Lissajous dual-axial scan component 100 is driven. The memory 116 stores multiple tuples each including a first-axial bias frequency value, a second-axial bias frequency value, and a phase difference (φ) between the first-axial bias frequency and the second-axial bias frequency. Each tuple corresponds to a particular pair of ranges of first-axis and second-axis resonant frequencies.

The controller 114 is coupled to the sensing arrangement 112 to receive signals indicative of the resonant frequencies, i.e. the first-axis resonance frequency and the second-axis resonance frequency. The controller 114 selects one of the tuples from the memory 116 based on the signals received from the sensing arrangement 112. The controller 114 sets the applied bias frequencies, and their phase, according to the selected triple.

The mirror 110 may be a MEMS mirror. The MEMS mirror may form the basis, for example, of a micro-scanner, or any other bi-axial scanners, etc. The sensing arrangement 112 may include one or more sensors. The one or more sensors may he resonant sensors to monitor the first-axis resonance frequency and the second-axis resonance frequency. The controller 114 may include a microcontroller (MCU) or a microprocessor or a digital signal processor (DSP).

In an embodiment, combinations of driving frequencies, i.e. the first-axial bias frequency and the second-axial bias frequency, and their phase difference (φ) that provide the desired degree of illumination are predetermined and stored in the memory 116 as tuples. The memory 116 electronically stores the combinations of the driving frequencies and their phase difference (φ) as tuples. The tuples may he defined as a finite ordered list of elements.

Signals received from the sensing arrangement 112 enable the controller 114 to switch to another setting that is determined by one of the stored triples based on a change that is identified in at least one of the first-axis resonance frequency and the second-axis resonant frequency. The controller 114 of the Lissajous dual-axial scan component 100 may identify another tuple that is stored in the memory 116 based on a new combination of the first-axis resonance frequency and the second-axis resonance frequency, if the sensing arrangement 112 identifies an above threshold change in at least one of the first-axis resonance frequency and the second-axis resonance frequency. The controller 114 adjusts the drive frequencies, i.e. the first-axial bias frequency and the second-axial bias frequency and their phase offset based on the appropriate tuple.

Sensing arrangement 112 is preferably configured provides a reliable sense signal for each axis of rotation, each sense signal containing information about the movement of the mirror on that particular axis. In a best case scenario, this signal consists only of one harmonic which exactly represents the mirror's movement. In this case, this signal could be analyzed electronically so that one ends up with a number representing the actual frequency. In other cases, this signal is filtered, and analyzed by the controller 114.

According to a first embodiment, the ratio of the first-axis resonance frequency to the second-axis resonance frequency is at least 20 to 1. The ratio of the first-axis resonance frequency to the second-axis resonance frequency is optionally at least 30 to 1. The ratio of the first-axis resonance frequency to the second-axis resonance frequency is optionally at least 40 to 1. The first and second rotational axes 105, 107 are optionally orthogonal to each other. The ratio of the first-axis resonance frequency to the second-axis resonance frequency is optionally a rational number. The ratio of the first-axis resonance frequency to the second-axis resonance frequency is optionally an irrational number.

The controller 114 is preferably configured to drive the Lissajous dual-axial scan component 100 with a frame repetition rate between 25 and 35 Hz, although higher repetition rates may be used without loss of apparent smoothness. The frame repetition rate may be, for example, 25, 26, 27, 28, 29, 30, 31, 32, 33, 34 or 35 Hz. The frame repetition rate is a number of frames or images that are repeated per second. The frame repetition rate is considered when deciding which combinations of the driving frequencies and their phase difference (φ) to be stored in the memory 116. The combinations of the driving frequencies and their phase difference (φ) that provide desired degree of illumination may he determined numerically and iteratively or by measuring using a sample device.

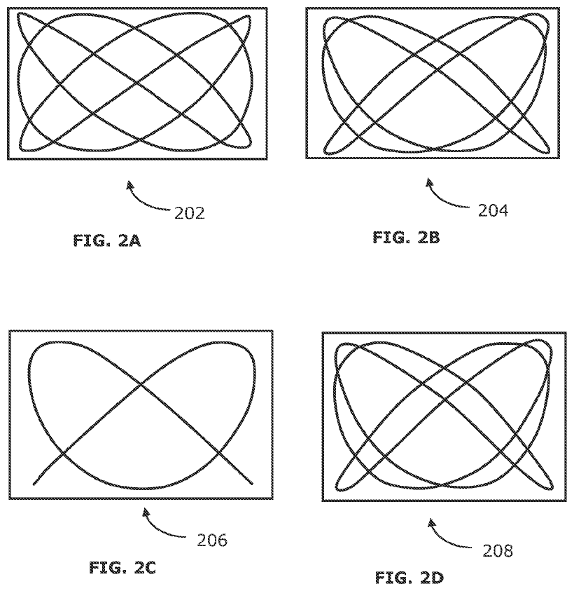

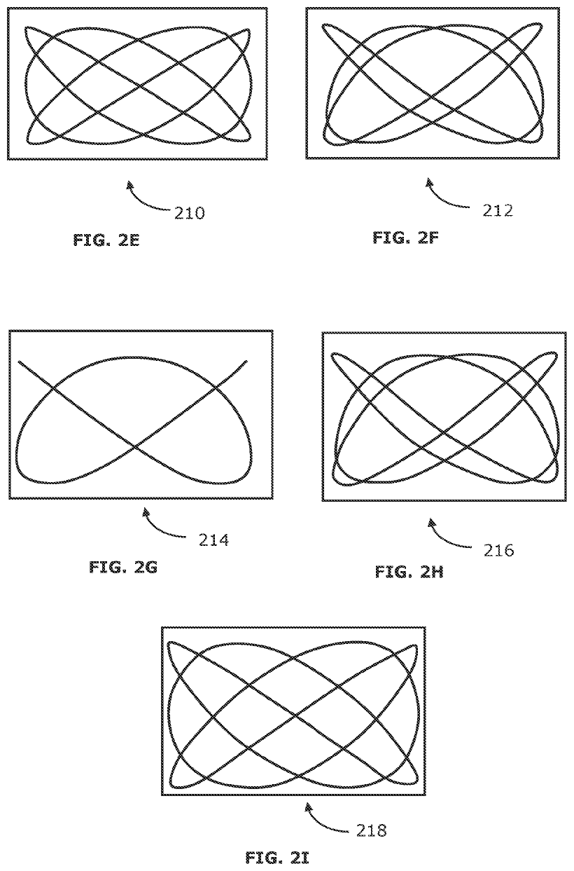

FIGS. 2A-2I illustrate Lissajous curves for different values of a phase difference (φ) at same values of multiplicators nₓ and n_{y}. The Lissajous curve, also known as a Lissajous figure or a Bowditch curve, is a graph of a system of parametric equations that describe complex harmonic motion. The shape of Lissajous curves is defined by the irreducible fraction of the driving frequencies of the two oscillations generating the trajectory, and their phase difference (φ).

In FIG. 2A of a Lissajous curve 202, the phase difference (φ) is 0 and the multiplicators nₓ is 3 and n_{y} is 4. In FIG. 2B of a Lissajous curve 204, the phase difference (φ) is 0.262

$$( i . e . , \frac{1}{8} ⋆ \frac{2 π}{3} )$$

and the multiplicators nₓ is 3 and n_{y} is 4. In FIG. 2C of a Lissajous curve 206, the phase difference (φ) is 0.523

$$( i . e . , \frac{2}{8} ⋆ \frac{2 π}{3} )$$

and the multiplicators nₓ is 3 and n_{y} is 4. In FIG. 2D of a Lissajous curve 208, the phase difference (φ) is 0.785

$$( i . e . , \frac{3}{8} ⋆ \frac{2 π}{3} )$$

and the multiplicators nₓ is 3 and n_{y} is 4. In FIG. 2E of a Lissajous curve 210, the phase difference (φ) is 1.047

$$( i . e . , \frac{4}{8} ⋆ \frac{2 π}{3} )$$

and the multiplicators nₓ is 3 and n_{y} is 4. In FIG. 2F of a Lissajous curve 212, the phase difference (φ) is 1.309

$$( i . e . , \frac{5}{8} ⋆ \frac{2 π}{3} )$$

and the multiplicators nₓ is 3 and n_{y} is 4. In FIG. 2G of a Lissajous curve 214, the phase difference (φ) is 1.570

$$( i . e . , \frac{6}{8} ⋆ \frac{2 π}{3} )$$

and the multipticators nₓ is 3 and n_{y} is 4. In FIG. 2H of a Lissajous curve 216, the phase difference (φ) is 1.832

$$( i . e . , \frac{7}{8} ⋆ \frac{2 π}{3} )$$

and the multiplicators nₓ is 3 and n_{y} is 4. In FIG. 2I of a Lissajous curve 218, the phase difference (φ) is 2.094

$$( i . e . , \frac{8}{8} ⋆ \frac{2 π}{3} )$$

and the multiplicators nₓ is 3 and n_{y} is 4.

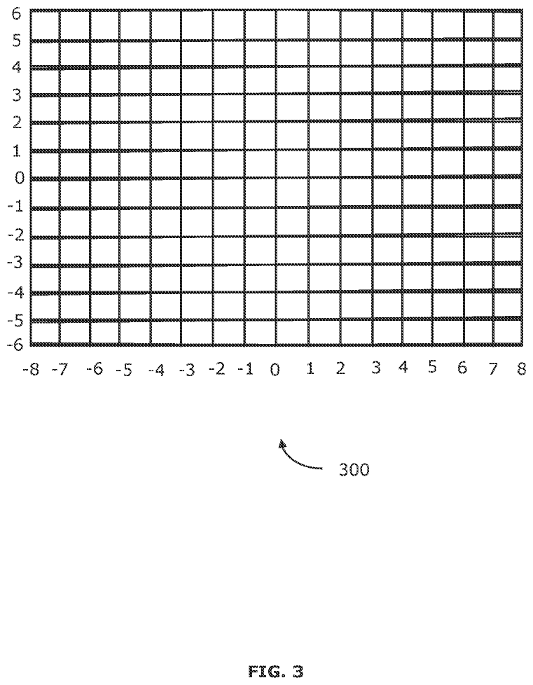

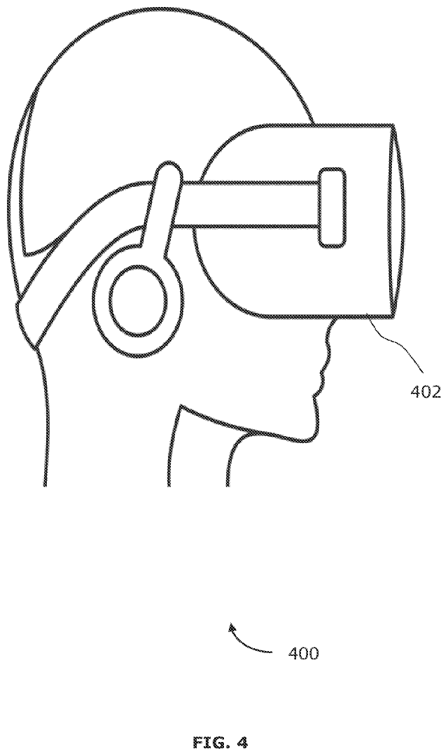

FIG. 3 is a Lissajous pattern 300 that is close to a raster scan pattern, which allows a greater number of pixels of an image for scanning in accordance with an embodiment of the present disclosure. In an embodiment, a current phase difference (φ) and the Lissajous pattern 300 has to be observed using positioning detection on the first rotational axis 105 and the second rotational axis 107. If nₓ is greater than n_{y} (nₓ»n_{y}), the Lissajous pattern is close to the raster scan pattern that allows the greater number of pixels of the image for scanning. In FIG. 3, the Lissajous pattern 300 illustrates the image that includes the multiplicators nₓ=1697 and n_{y}=22 in the centre of the image which allows Full High-definition (HD) videos to be projected on a screen. If the multiplicators nₓ and n_{y}are high, High-Definition (HD) images and the High-definition (HD) videos may be projected on the screen. In an embodiment, a number on axes are a number of pixels on a respective axis.

FIG. 4 is an exemplary view 400 that illustrates a visual display device 402 that includes one or more Lissajous dual-axial scan components 100 of FIG. 1 in accordance with an embodiment of the present disclosure. The visual display device 402 includes the one or more Lissajous dual-axial scan components 100 that scan according to a ratio of a first-axial bias frequency to a second-axial bias frequency when the one or more Lissajous dual-axial scan components 100 are driven. The visual display device 402 may be a device that is used for presentation of images, text, or video transmitted electronically. The visual display device 402 may be a head-mounted visual display device. The visual display device 402 may include a direct digital synthesis (DDS) device to generate the first-axial bias frequency and the second-axial bias frequency. The direct digital synthesis device may generate signals to drive the first rotational axis 105 and the second rotational axis 107 of the one or more Lissajous dual-axial scan components 100. The first rotational axis 105 and the second rotational axis 107 may be driven using the DDS device by setting a phase input of the DDS device.

In an embodiment, the visual display device 402 includes an electronic circuit and a memory that stores tuples, each tuple comprising a combination of two driving frequencies and their phase difference. The electronic circuit receives signals from a sensing arrangement that monitors the first-axis resonance frequency and the second-axis resonance frequency. The electronic circuit identities a tuple that is stored in the memory, based on a new combination of the first-axis resonance frequency and the second-axis resonance frequency if the electronic circuit identities any changes in at least one of the first-axis resonance frequency and the second-axis resonance frequency. A thresholding arrangement is used, with each tuple corresponding to a range of first resonant frequencies and a range of second resonant frequencies, so that changes in either or both resonant frequency that do not require a change in drive frequency or phase to ensure continuance of a desired fill factor do not result in any change in in drive frequencies or phase. The electronic circuit sets the applied bias frequencies, and their phase, according to the tuple appropriate for the instantaneous resonant frequency combination.

The one or more Lissajous dual-axial scan components 100 in the visual display device 402 enhance illumination and line density on a screen and also provide a smooth visual perception of moving images. The one or more Lissajous dual-axial scan components 100 in the visual display device 402 have both high mechanical stability and low operating voltages.

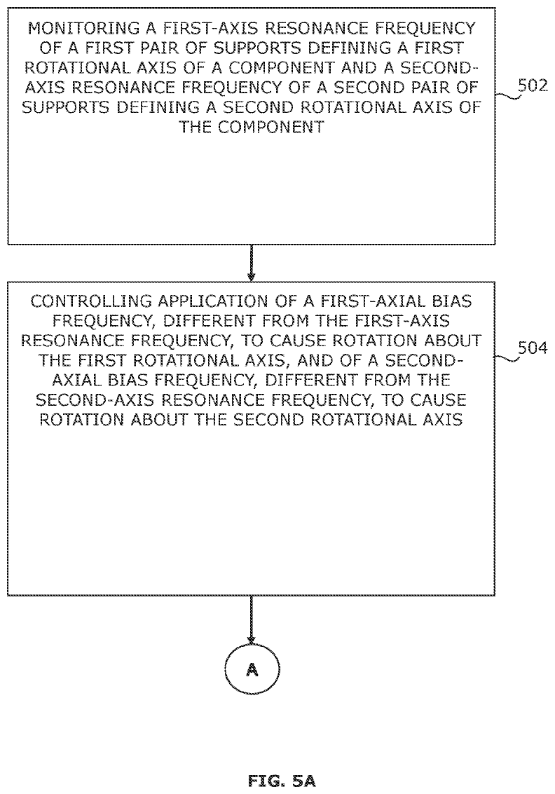

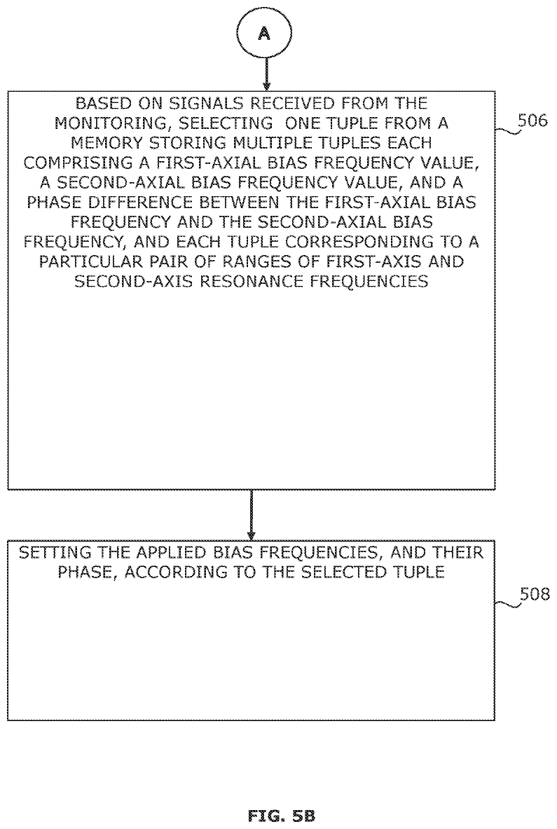

FIGS. 5A-5B are flow diagrams that illustrate a method of controlling the Lissajous dual-axial scan component 100 in accordance with an embodiment of the present disclosure. At step 502, a first-axis resonance frequency of the first pair of supports 104A-B defining the first rotational axis 105 of the Lissajous dual-axial scan component 100 and a second-axis resonance frequency of the second pair of supports 106A-B defining the second rotational axis 107 of the Lissajous dual-axial scan component 100 are monitored. At step 504, application of a first-axial bias frequency, different from the first-axis resonance frequency, to cause rotation about the first rotational axis 105, and of a second-axial bias frequency, different from the second-axis resonance frequency, to cause rotation about the second rotational axis 107 are controlled. At step 506, based on signals received from the monitoring, one tuple is selected from the memory 116 storing multiple tuples each comprising a first-axial bias frequency value, a second-axial bias frequency value, and a phase difference (φ) between the first-axial bias frequency and the second-axial bias frequency, and each tuple corresponding to a particular pair of ranges of first-axis and second-axis resonance frequencies. At step 508, the applied bias frequencies, and their phase, are set according to the selected tuple.

The first-axis resonance frequency and the second-axis resonance frequency may be monitored continuously, but they may also be monitored intermittently at a rate high enough to ensure continued good optical performance. Another tuple of the multiple stored tuples are selected in response to any significant change in signals received from the monitoring. A significant change is here one that necessitates a change in the applied bias frequencies or phase in order to maintain a desired fill factor or other aspect of optical performance. The applied bias frequencies, and their phase, are set according to the selected another tuple.

Oscillations on the first rotational axis 105 and the second rotational axis 107 of the Lissajous dual-axial scan component 100 can be written as

x(t)=sin(2πnₓfᵣₑₛt)

y(t)=sin(2πnₓfᵣₑₛt+φ)

where nₓ and n_{y} are multiplicators that determine the shape of the Lissajous curves, and fₓ and f_{y} are the driving frequencies of the mirror 110, i.e. a first-axial bias frequency and the second-axial bias frequency and fᵣₑₛ denotes a repetition frequency of the Lissajous curves, whereas scanning frequencies on the first rotational axis 105 and the second rotational axis 107 are

fₓ=nₓ*fᵣₑₛ and f_{y}=n_{y}*fᵣₑₛ

The repetition frequency (fᵣₑₛ) should be sufficient for a smooth perception of a projected video (assuming that the video is of a moving image). To achieve a high enough line density or fill factor, it is desirable for the irreducible fraction nₓ/n_{y} to be large

For example, if the driving frequencies fₓ=27600 Hz and f_{y}=690 Hz, one or more combinations of nₓ, n_{y}, fᵣₑₛ are possible within a certain range of the driving frequencies (fₓ and f_{y}), e.g., fᵣₑₛ=690 Hz, nₓ=40, n_{y}=1 or fᵣₑₛ=36.316 Hz, nₓ=13, n_{y}=760 with resulting frequencies of fₓ=27600.16 Hz and f_{y}=690.004 Hz. The latter combination is a lot better suited far projection applications, as the frame rate is sufficient to allow smooth visual perception While nₓ and n_{y} are maximised. In projection applications, a frame rate that enables smooth visual perception if the multiplicators nₓ and n_{y} are maximized.

By making

$${f}_{res} = \frac{{f}_{x}}{{n}_{x}} = \frac{{f}_{y}}{{n}_{y}}$$

greater than at least 24 Hertz (Hz) smooth perception of a video is possible (and typically it may be convenient to work with a repetition frequency in the range 24 to 35 fps). The fraction of

$$\frac{{n}_{x}}{{n}_{y}} ≫ 20$$

allows better line density, and preferably

$$\frac{{n}_{x}}{{n}_{y}} ≫ 30 ,$$

and more preferably

$$\frac{{n}_{x}}{{n}_{y}} ≫ 40.$$

This requires the mirror 110, (e.g. MEMS mirror) with the resonance frequencies according to that rule, as

$$\frac{{n}_{x}}{{n}_{y}} = \frac{{f}_{x}}{{f}_{y}} .$$

### EXAMPLE

With the example given above of a MEMS mirror with rough resonance frequencies of fx=27600 and fy=690 Hz respectively, we estimate a maximum fluctuation in those resonance frequencies on both axes. Let us say on the fast axis it fluctuates between 27590 and 27610 Hz and on the slow axis between 688 and 692 Hz depending on the conditions imaginable. We then know that the minimum multiplicator nx_min for the fast axis would be 788, as 788*35 Hz roughly equals 27590 Hz, while the maximum multiplicator nx_max is 1104, because 1100*25 Hz roughly equals 27610 Hz. Accordingly the range for all possible multiplicators ny can be calculated to be 19 to 27.

Then all imaginable combinations of allowed driving frequencies can be calculated numerically and iteratively. First one has to check all possible pairs of multiplicators nx and ny in the aforementioned ranges whether they are coprime. If they are, they are stored, if they are not, they are discarded. 19 and 788 e.g. are stored, as the greatest common divisor (gcd) of (19,788)=1, whereas 20 and 788 are discarded, as gcd of (20,788)=4. In this way one ends up with a list of coprime numbers that could lead to possible driving frequencies within the allowed range above.

One could implement a Python script where these pairs of coprime multiplicators are stored pairwise in a numpy vector in the memory 116.

If one now multiplies this numpy vector with all frame rates within the allowed range, a large number of allowed driving frequencies is generated. For example, with one pair of multiplicators of 19 and 788 and a frame rate of exactly 25 Hz, the resulting driving frequencies are 475 Hz and 19700 Hz. In this particular example, this pair is discarded though, as it's too far away from the resonance frequencies, thus one does not have to store it in the ROM mentioned. If one takes another coprime pair of multiplicators, e.g. nx=842 and ny=21, one actually is within the assumed range of resonance frequency fluctuation with a resonance frequency of 32.78 Hz for example (842*32.78 Hz=27600.76 Hz, 21*32.78 Hz=688.38 Hz). So we can implement a Python script as mentioned that takes the generated numpy vector of coprime multiplicators and iteratively multiples those with all resonance frequencies in the range mentioned above, starting at 25 Hz, 25.0001 Hz and so on up to 35 Hz. All of the resulting matrices of frequency pairs are then filtered so that they satisfy the condition for the fluctuation of resonance frequencies as described.

It will be appreciates that this is a rather long and demanding mathematical operation, and it is for this reason that it is done beforehand and then stored in memory 116.

Although the present invention and its advantages have been described in detail, it should be understood that various changes, substitutions and alterations can he made herein without departing from the spirit and scope of the invention as defined by the appended claims.

1. A Lissajous dual-axial scan component comprising:
an outer frame;
a first pair of supports defining a first rotational axis and configured to twist at a first-axis resonance frequency when the Lissajous dual-axial scan component is driven;
a second pair of supports defining a second rotational axis and configured to twist at a second-axis resonance frequency when the Lissajous dual-axial scan component is driven;
an inner frame connected to the outer frame through the second pair of supports;
a mirror connected to the inner frame through the first pair of supports;
a sensing arrangement to monitor the first-axis resonance frequency and the second-axis resonance frequency; and
a controller to control application of a first-axial bias frequency, different from the first-axis resonance frequency, to cause rotation about the first rotational axis, and of a second-axial bias frequency, different from the second-axis resonance frequency, to cause rotation about the second rotational axis;
wherein the Lissajous dual-axial scan component, when driven, scans according to a ratio of the first-axial bias frequency to the second-axial bias frequency;
a memory storing multiple tuples each comprising a first-axial bias frequency value, a second-axial bias frequency value, and a phase difference between the first-axial bias frequency and the second-axial bias frequency, and each tuple corresponding to a particular pair of ranges of first-axis and second-axis resonant frequencies;
the controller being coupled to the sensing arrangement to receive signals indicative of the resonant frequencies, and configured to:
select one of the tuples from the memory based on the signals received from the sensing arrangement; and
set the applied bias frequencies, and their phase, according to the selected tuple.

2. The Lissajous dual-axial scan component of claim 1, wherein the ratio of the first-axis resonance frequency to the second-axis resonance frequency is at least 20 to 1.

3. The Lissajous dual-axial scan component of claim 2, wherein the ratio of the first-axis resonance frequency to the second-axis resonance frequency is at least 30 to 1.

4. The Lissajous dual-axial scan component of claim 3, wherein the ratio of the first-axis resonance frequency to the second-axis resonance frequency is at least 40 to 1.

5. The Lissajous dual-axial scan component of claim 1, wherein the first and second rotational axes are orthogonal to each other.

6. The Lissajous dual-axial scan component of claim 1, wherein the ratio of the first-axis resonance frequency to the second-axis resonance frequency is a rational number.

7. The Lissajous dual-axial scan component of claim 1, wherein the ratio of the first-axis resonance frequency to the second-axis resonance frequency is an irrational number.

8. The Lissajous dual-axial scan component of claim 1, wherein the controller is configured to drive the scan component with a frame repetition rate between 25 and 35 Hz.

9. A visual display device including one or more Lissajous dual-axial scan components according to claim 1.

10. The visual display device of claim 8, further comprising a direct digital synthesis device to generate the first-axial bias frequency and the second-axial bias frequency.

11. A method of fabricating a Lissajous dual-axial scan component according to claim 1, the method comprising writing multiple tuples into a memory of the component, each tuple comprising a first-axial bias frequency value, a second-axial bias frequency value, and a phase difference between the first-axial bias frequency and the second-axial bias frequency, and each tuple corresponding to a particular pair of ranges of first-axis and second-axis resonance frequencies.

12. A method of controlling a Lissajous dual-axial scan component, the method including:
monitoring a first-axis resonance frequency of a first pair of supports defining a first rotational axis of the component and a second-axis resonance frequency of a second pair of supports defining a second rotational axis of the component;
controlling application of a first-axial bias frequency, different from the first-axis resonance frequency, to cause rotation about the first rotational axis, and of a second-axial bias frequency, different from the second-axis resonance frequency, to cause rotation about the second rotational axis; and,
based on signals received from the monitoring, selecting one tuple from a memory storing multiple tuples each comprising a first-axial bias frequency value, a second-axial bias frequency value, and a phase difference between the first-axial bias frequency and the second-axial bias frequency, and each tuple corresponding to a particular pair of ranges of first-axis and second-axis resonance frequencies; and
setting the applied bias frequencies, and their phase, according to the selected tuple.

13. The method of claim 12, further comprising:
continuing monitoring the first-axis resonance frequency and the second-axis resonance frequency;
in response to a change in signals received from the monitoring selecting another tuple of the multiple stored tuples; and
setting the applied bias frequencies, and theft phase, according to the selected another tuple.

14. The method of claim 12, wherein the ratio of the first-axis resonance frequency to the second-axis resonance frequency is at least 20 to 1.

15. The method of claim 14, wherein the ratio of the first-axis resonance frequency to the second-axis resonance frequency is at least 30 to 1.

16. The method of claim 15, wherein the ratio of the first-axis resonance frequency to the second-axis resonance frequency is at least 40 to 1.

17. The method of claim 12, wherein the ratio of the first-axis resonance frequency to the second-axis resonance frequency is a rational number.

18. The method of claim 12, wherein the ratio of the first-axis resonance frequency to the second-axis resonance frequency is an irrational number.

19. The method of claim 12, wherein the controlling of the first-axial and second-axial bias frequencies is such as to produce a frame repetition rate between 25 and 35 Hz.
